(19) United States
(12) Patent Application Publication
(10) Pub. No.: US 2010/0011207 A1
(43) Pub. Date: Jan. 14, 2010

(54) Service Oriented Architecture Device

(75) Inventors: Barry R. Fox, Ballwin, MO (US); Ronald J. Howard, Chesterfield, MO (US); Kenneth J. Moroney, Chesterfield, MO (US)

Correspondence Address: LEE & HAYES, PLLC, 601 W. RIVERSIDE AVENUE, SUITE 1400, SPOKANE, WA, 99201, US

(73) Assignee: The Boeing Company, Chicago, IL (US)

(21) Appl. No.: 12/171,845

(22) Filed: Jul. 11, 2008

(51) Int. Cl. H04L 9/00; H04K 1/00; G06F 15/173

(52) U.S. Cl. 713/155; 380/255; 709/225

(57) ABSTRACT

A system for Service Oriented Architecture (SOA) communication includes a plurality of SOA nodes having a standardized hardware configuration, wherein the standardized hardware configuration includes an operating engine, an encryption module accessed by the operating engine, which provides security for message traffic, a compression module to compress and decompress the message traffic, a routing module accessed by the operating engine, to determine the routing of message types, incoming traffic routed to appropriate service clients, outbound traffic routed to appropriate SOA devices, a security module that authenticates and authorizes message traffic, and one or more network interfaces, and one or more networks over which the SOA nodes communicate with one another.

### FIELD OF THE INVENTION

The field of the present disclosure is directed to Service Oriented Architecture (SOA) devices, systems, and networks.

### BACKGROUND OF THE INVENTION

Service Oriented Architectures or SOAs include devices, systems, and networks which are directed to providing structured communications between one or more computing devices or a collection of such computing devices, and in particular applications residing or supported by systems and computing devices. An SOA system allows a structured exchange between such computing devices and systems. In certain cases, a specific language may be used for format or predefined message content. Such languages include eXtensible Markup Language or XML, and Electronic Data Interchange or EDI.

In certain cases, multiple systems may provide multiple services. A system and/or computing device may ask other systems and/or computing devices for services or information. For example, one system or computing device may ask another system or computing device (i.e., resident or supported application) to provide a service or exchange particular information. An SOA allows for the service to be provided and/or information to be exchanged.

An example of an SOA system includes a website that sells goods to online customers, and uses a credit card clearing house to verify customers' credit cards. The website sells the goods, and a customer's credit card information or status is verified by the credit card clearing house. The credit clearing house provides a service and/or information to the website selling the goods.

SOA systems may be set up using a manual ad hoc procedure that may involve a long and complex process of providing specific structures for communications between specific SOA partners (e.g., the website and the credit card clearing house). Such implementations typically do not lend themselves to supporting new or third parties (e.g., a new or different credit card clearing house).

Another approach in setting up SOA systems is the use of software products that specifically provide SOA support. Such software products are unique to a party and vendor (e.g., website and credit card clearing house). In certain cases, the software products cannot be migrated to support other parties. Furthermore, such software products may provide limited interoperability. In cases when a new SOA party (e.g., new credit card clearing house) is added, a new license may be needed to add the new party. Typically, specific software may be needed to tie in a system with one another system, and recreate a new relationship and environment whenever a new party is added.

Yet another approach includes the use of standardized hardware to provide structured communications between SOA parties (e.g., website and credit card clearing houses). Such hardware includes routers and switches which incorporate or use the same standards. In this approach, implementation of the same or compatible hardware between parties may be required.

### SUMMARY

The Service Oriented Architecture (SOA) device with the teachings of the present disclosure may advantageously provide secured, standardized, and simplified communications between SOA devices and systems.

In one embodiment, an SOA device connected to a network, serving as a central authority for routing SOA traffic between applications that provide services into the network, wherein the SOA device is single indivisible package includes an operating engine configured to access encryption, compression and routing to support an operational requirement, an encryption module accessed by the operating engine, which provides security for external and internal message traffic, a compression module to compress and decompress the message traffic, a routing module accessed by the operating engine, to determine the routing of at least one of message types, incoming traffic routed to appropriate service clients, and outbound traffic routed to an appropriate SOA device for disposition, a security module configured to authenticate external traffic, such that messages are exchanged between SOA devices that have established a trust relationship, and to authorize authenticated traffic for further processing, a first network interface used to connect the device to a local area network (LAN), and a second network interface used to connect the device to an external wide area networks (WAN).

In another embodiment, a system for SOA communication includes a plurality of SOA nodes having a standardized hardware configuration, wherein the standardized hardware configuration includes an operating engine, an encryption module accessed by the operating engine, which provides security for message traffic, a compression module to compress and decompress the message traffic, a routing module accessed by the operating engine, to determine the routing of message types, incoming traffic routed to appropriate service clients, outbound traffic routed to appropriate SOA devices, a security module that authenticates and authorizes message traffic, and one or more network interfaces, and one or more networks over which the SOA nodes communicate with one another.

In yet another embodiment, a method includes determining SOA clients, and whether the SOA clients are at least one of consumers and producers, creating an application program interface at each client, requesting a list of configured SOA servers that the SOA clients are authorized to request, requesting a list of authorized services the SOA clients are to provide.

The features, functions, and advantages that have been discussed above or will be discussed below can be achieved independently in various embodiments, or may be combined in yet other embodiments, further details of which can be seen with reference to the following description and drawings.

### BRIEF DESCRIPTION OF THE DRAWINGS

Embodiments of systems and methods in accordance with the teachings of the present disclosure are described in detail below with reference to the following drawings.

FIG. 1 is a block diagram of high level SOA systems communicating with another, using Service Oriented Architecture devices.

FIG. 2 is block diagram of a variable layer and standardized layer of a Service Oriented Architecture device.

FIG. 3 is a block diagram of a Service Oriented Architecture device showing logical components and paths.

FIG. 4 is a block diagram of a Service Oriented Architecture device showing physical components.

FIG. 5 is a flowchart illustrating communications through Service Oriented Architecture devices. As used herein, the term exemplary is meant to identify an example and not necessarily an ideal.

### DETAILED DESCRIPTION

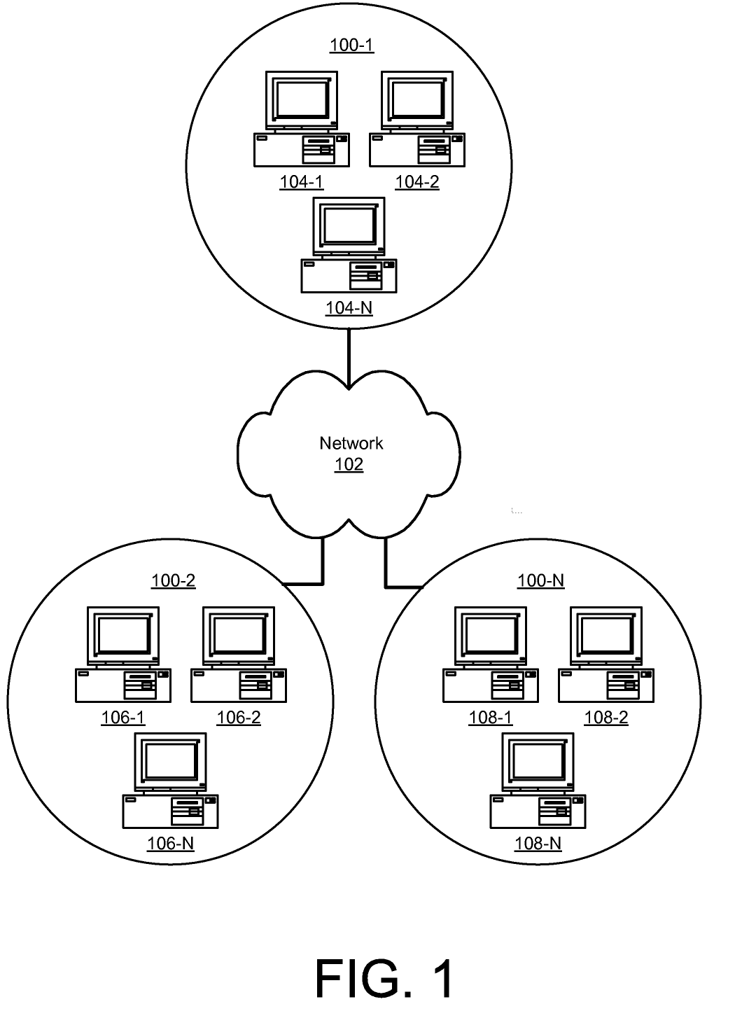

The present disclosure teaches systems and methods for a Service Oriented Architecture or SOA device. Many specific details of certain embodiments of the invention are set forth in the following description and in FIGS. 1-5 to provide a thorough understanding of such embodiments. One skilled in the art will understand that the invention may have additional embodiments, or that the invention may be practiced without several of the details described in the following description.

The described SOA device allows the ability to send/receive messages between computer programs or applications. The use of hardware provides an additional security layer, in particular where the use of a smart card and/or a universal service bus (USB) physical card is to be present, otherwise the SOA device cannot be used. Furthermore, security is further enhanced by persistent storage that may be removed and destroyed, preventing unauthorized parties from using the SOA device.

The described SOA device may be implemented as a network enabled hardware based device that may be connected to various networks. The SOA device may serve as a central authority for routing SOA traffic between applications that provide services into a given network.

From the perspective of the public Internet, the SOA device may look like a firewall switch. Standardized Internet Protocol or IP packets may be used for traffic between SOA nodes (where nodes are particular devices or systems). The IP packets may be compressed and encrypted. IP addresses of SOA nodes may be known by a privately configured secured network server. In addition to compression and encryption, the SOA device may perform domain name service (DNS) and IP based routing of business messages. The SOA device is physically trivial to install and configure. SOA business applications may be invoked by the SOA device by a “remote procedure call” or RPC “application program interface” or API. Each service (application) may be considered a class or object, where a service has one or more send procedures overloaded by the message. The SOA device may also have a callback method capability, initiated upon receipt of a message return.

FIG. 1 illustrates exemplary Service Oriented Architecture or SOA system 100 communicating with one another over a network or networks 102. In this example, one or more SOA systems are represented by SOA systems 100-1, 101-2, . . . , 102-N. The network or networks are represented by network 102. The network 102 can include various local area networks (LAN), wide area networks (WAN), wired and wireless networks, and the Internet.

Exemplary implementations of SOA systems 100 include single business enterprises, offices, departments, and factories of a business enterprise. E-Commerce and inter-business processes may also apply, including public e-commerce, inter-business auction and bidding processes (private and public). SOA systems 100 may also support financial business processes and transactions. Example businesses that may be supported by SOA systems 100 include printing and publication, medical business processes and transactions and defense business processes and transactions. Further implementations include providing secure SOA systems 100 for use in monitoring and situational awareness networks and for environments which may require implementations of business processes mediated by the exchange of messages between network-based services in a secure environment.

SOA systems 100 can include subsystems and/or computing devices. In communicating between one another, the SOA systems 100 may be considered as a node and/or a sub-system or computing device may be considered a node. In general, a node allows communication between SOA systems 100. Such nodes may be implemented with the described SOA architecture that allows secured, standardized, and simplified communications between SOA devices and systems 100. Nodes in particular can act as a central authority for routing SOA traffic between software/computer programs or applications that provide services into a given network (e.g., network 102).

In this example, SOA system 100-1 includes computing devices 104-1, 104-2, . . . , 104-N. SOA system 100-2 includes computing devices 106-1, 106-2, . . . , 106-N. SOA system 100-N includes computing devices 108-1, 108-2, . . . , 108-N. Computing devices 104, 106, and 108 may be implemented using the described SOA device architecture. Computing devices 104, 106, and 108 may be one of various computing devices, including personal computers, laptops, desktops, server computers, etc. Computer programs or applications, such as SOA business applications, may be resident or accessed by computing devices 104, 106, and 108, where nodes of the devices provide communication using the described SOA device architecture.

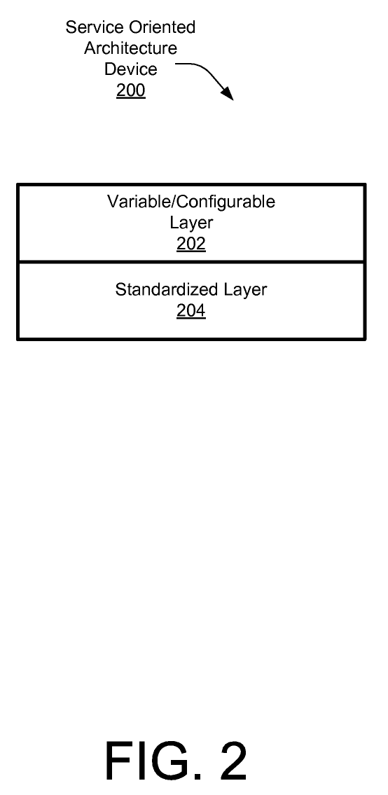

FIG. 2 illustrates exemplary layers of an SOA device 200. SOA device 200 may include computing devices 104, 106, and 108. In this example, SOA device 200 includes a variable or configurable layer 202 and a standardized layer 204. Layers 202 and 204 may be implemented in software, firmware, hardware, and/or a combination. In an embodiment, SOA device 200 combines capabilities required for secure messaging in a service oriented architecture in a single, indivisible package, eliminating the need for additional layers of software and eliminating the risk of incompatible software in an application server.

Certain communication or protocols may be standard or commonly used between SOA systems 100. For example, encryption or communication encryption packaging may be a standardized feature for the SOA systems 100. The encryption can be included in the standardized layer 204. The standardized layer 204 may be included as part of an operating system or non configurable software application of SOA device 200.

Variable layer 202 may include variable data that is entered or defined. For example, if any communication that is unique to, or particularly between SOA systems 100, such communication, or data related to the communication, may be included in variable layer 202 of SOA device 200. The variable layer 202 is set up specific to environments of one or more of the SOA systems 100.

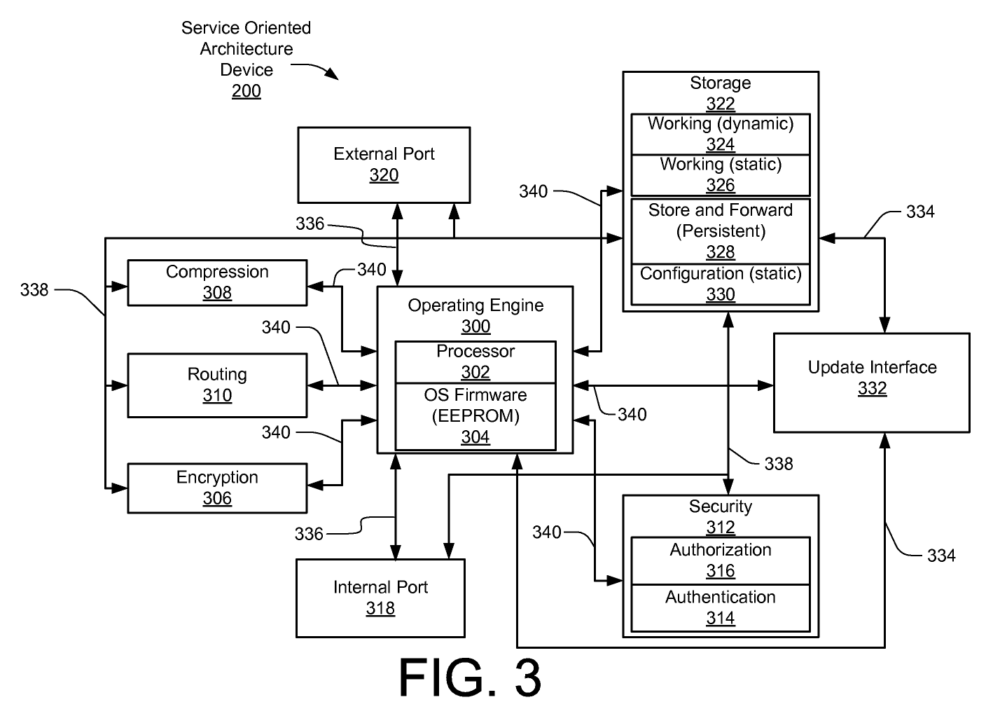

FIG. 3 illustrates exemplary logical components and paths of a SOA device 200. In this example, the SOA device 200 includes an operating engine 300, which may be considered a central processor(s) 304 of SOA device 200. The operating engine 300 may include operating system (OS) firmware, which may include an EEPROM 304. The operating system and applications (SOA business applications) are loaded from firmware storage 304. The operating engine 300 accesses functions such as encryption, compression and routing as needed to support configured operational requirements.

The example further shows an encryption component or module 306 used by the operating engine 300 to encrypt/decrypt messages, configurations, and authentications. Encryption algorithms and keys may be provided by secure configuration. Depending on the use of encryption, different algorithms and/or keys may be used by the encryption module 306. The encryption module 306 may be used to provide security for external traffic, and in certain cases internal traffic. The encryption module 306 may also be used by an update interface, which may be connected via the operating engine by proxy, to decrypt incoming firmware or configuration updates prior to saving them to configuration storage.

The SOA device 200 may include a compression component or module 308 that is used by the operating engine 300 to compress/decompress message traffic. The SOA device 300 may also include a routing component module 310 that determines routing of a message type. For example, incoming traffic may be routed to an appropriate service client(s), and outbound traffic may be routed to appropriate SOA device computer or server for disposition.

The SOA device 200 may include a security component or module 312, which includes an authentication component or module 314 and an authorization component or module 316. External traffic may be exchanged between SOA devices (e.g., servers) that have established a trust relationship. The trust relationship may be established by an authentication process where key-pairs are exchanged between SOA devices. This process may be performed by the authentication module 314. Internal traffic may be configured from among differing methods of authentication. The methods may range from clear-text client identifiers, to client signatures, to full trust relationships. In certain implementations, the SOA device 200 may implement a configuration process authentication that may require matched sets of “smart cards: and “configuration devices.”

The authorization module 316 may provide that any authorized messages are allowed to be passed on for further processing, and that any unauthorized messages are dropped. Authorized messages may be defined as messages that the authenticated client(s) are allowed by configuration to send/receive.

The SOA device 200 may include an internal port 318 and an external port 320 and may implement an Internet Protocol. The internal port 318 may be a network interface used for associated protocol stack processing used to connect the SOA device 200 to a local area network or LAN. The external port 320 may be a typical network interface used for associated protocol stack processing used to connect the SOA device 200 to an external wide area networks (WAN), such as the Internet.

The SOA device may include a storage component 322. Storage 322 may include four logical storage subcomponents described as follows. An area referred to as working dynamic 324 may be considered as main working memory of the operating engine 300. Only the present message in process may reside in this memory space, working dynamic 324. This memory area may work in conjunction with an area or subcomponent referred to as working static 326. When the operating engine 300 is processing a message, a copy of the message is transferred into working dynamic 324 for processing. This copy process ensures that no message content will be lost by power interruption.

The area or subcomponent referred to as working static 326 serves as a queue area for messages inbound and outbound from the ports 318 and 320. The operating engine 300 pulls messages from and pushes messages to working static 326 before and after processing. Ports 318 and 320 pull messages from working static 326 for transmission on the network. Ports 318 and 320 push messages into this area upon for processing.

If a message cannot be delivered or if delivery is interrupted, the message will continue to sit in working static 326 awaiting retry or message timeout. By allowing working static 326 to be increased using a persistent memory or an area or subcomponent referred to as store and forward 328, expansion capability, greater depth of queuing can be achieved to meet specific needs. Network latency and reliability are some of the factors that may affect the need for greater capacity for store and forward 328.

Configuration memory 326 allows for SOA device 200 to have multiple subsystem configuration elements. These subsystem configuration elements can be one of, but not limited, to service definitions which are definitions of service messages that are exposed by the SOA device 200. These represent both internally and externally available services.

Subsystem configuration elements may also include service provider definition, which provide that external service providers are defined by the address of SOA device(s) providing services. Internal service providers may be defined by the identifier (ID) of the internal client that will provide the service. Service definitions in conjunction with provider definitions may be used to generate entries in a routing table. The routing table provides configurable control of message traffic destinations. The routing table supports both internal and external routing. An external address of a service provider may be determined by the addresses configured within the service provider definition. The internal address of a service provider may be determined dynamically during initialize routines between the SOA device 200 and clients.

There may be three main security areas stored in configuration 330. The first area may be configuration area. An initial SOA device 200 configuration may require physical access to the device. The SOA device 200 may be configured to require physical access for all future updates or may be configured for remote configuration capability protected by strong encryption and security measures. The second area may be referred to as “external” or “external security” which may be supported by certificate trust relationships. The third area may be referred to as “internal” where there may be multiple internal security models that are configurable based upon deployment scenario and the security requirements.

The SOA device 200 may also include an update interface 332 that allows remote and local access to upload firmware and configuration updates. The update interface 332 communicates and sends/receive configuration updates through logical paths “configuration updates” 334 between the operating engine and storage 322.

Other logical paths include “traffic flows” 336 between the ports 318 and 320, and the operating engine 300. Logical paths “supporting” processes 338 may be provided between storage 322 and the encryption module 306, the compression module 308, and the routing module 310. Logical paths “configuration consumers” 340 may also be provided as shown.

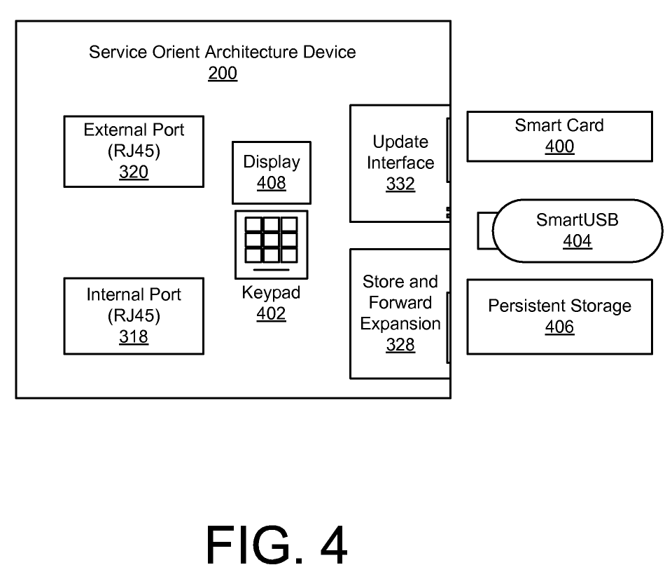

FIG. 4 illustrates exemplary physical components of a SOA device 200. A smart card 400 may contain identity information for the SOA device 200, which provides and identifies the SOA device 200 with authentication credentials such that it can communicate with other SOA devices or servers on its network. The smart card 400 may also contain an initial certificate and private key that may be needed by the encryption module 306. In a typical scenario, the SOA device 200 cannot operate without its keyed smart car 400. When the smart card 400 is inserted into the SOA device 200, a user may be prompted to enter a PIN using a keypad 402.

A USB interface on the update interface 332 may be provided. The USB interface allows for the insertion of a USB storage device 404. The USB storage device 404 may contain encrypted binaries containing configuration updates and/or firmware updates. Contents of the USB storage device 404 may be written using provided configuration software.

Internal port 318 and external port 320, as described above, may be configured as RJ45 ports which are provided for standard TCP/IP connection to internal and external networks. Internal networks are expected to be a private LAN and external networks are expected to be unsecured public networks (such as the Internet).

A physical slot may be provided to extend persistent storage 406, and to particularly extend or expand functionality of store and forward 328. Furthermore, in addition to the keypad 402, a digital display or display 408 may be provided. The keypad 402 and display 408 may be used to enter a required PIN to active the smart card 400 and to initially configure the SOA device 200.

In certain physical implementations, SOA device 200 may be in the form of a single printed circuit board that may be used in a computer or backplane. SOA device may also be in the form of a single Personal Computer Memory Card International Association or PCMCIA card or similar device that may be inserted into a computer. Another form includes a printed circuit board or PCMCIA that is inserted into a network router or switch. Yet another form may be a single integrated circuit for incorporation into a computer motherboard or similar computer level integration.

### Exemplary Device Sequences

For initial configuration, the following power on sequence may take place. The SOA device 200 may an initial configuration procedure by which device operational mode, security features, and initial services are defined. The SOA device 200 may access a smart card reader (i.e., smart card 400). If the smart card 400 is not present, SOA device 200 may shut down. If the smart card 400 is present, the SOA device 200 may validate smart card 400 credentials against SOA device 200 allowable configuration provider credentials. If such credentials fail to validate, the SOA device 200 may shut down. If the credentials are valid, the device may requests user PIN input for final validation. If the PIN is valid, the SOA device 200 may configure itself. Additional configuration settings may be requested from the user during configuration process.

Power on sequence may apply to various scenarios, including “No smart card 400 present” and “smart card 400 present.” If “No smart card 400 present”, the SOA device 200 during boot-up, may examine its internal configuration settings. If it has been configured to operate as trusted remote device, SOA device 200 may examine present configuration against configuration security keys. If the configuration has been compromised, SOA device 200 may transition to safe mode allowing only remote security and administrative functions to be accessed. If the SOA device 200 is configured to be A local device, then SOA device 200 may switch to standby and no configured services may be available until a paired smart card is inserted. Once a smart card is inserted, the device will follow the interaction specified in section can follow the sequence “smart card 400 present”. The sequence “smart card 400 present” is a as follows. When smart card 400 is inserted, the device 200 may perform the following boot-up tasks: 1) confirm the smart card 400 is correctly keyed to the device, 2) prompt and wait for correct password to be entered via the keypad 402, 3) decrypt and load configuration, including routing table, from storage, 4) enable RJ45 ports 318 and 320 and accept incoming requests, and 5) review store-and-forward storage and begin processing stored requests, if any.

In a sequence for incoming requests from an external network, the SOA device 200 may receive a request on the external port 320, and the SOA device 200 may perform the following tasks: 1) receive and store entire request, 2) decompress/de-encrypt request, 3) verify message authenticity (i.e. verify requester is authorized to send this request). If not authorized, drop message without further processing, 4) use message/service type to lookup routing information from routing table, 5) ping destination server, 6) send request to destination.

In a sequence for incoming requests from an internal network, the SOA device 200 may receive a request on the external port 320, and the SOA device 200 may perform the following tasks: 1) receive and store entire request, 2) verify message authenticity (i.e. verify requester is authorized to send this request). If not authorized, drop message without further processing, 3) use message/service type to lookup routing information from routing table, 4) compress and encrypt request, 5) ping destination server, 6) send request to destination.

In a sequence for “shutdown”, the SOA device 200 may be shut down either intentionally or unintentionally, both of which may be handled in the same manner. The core operational process model of the SOA device 200 may ensure that service request and/or response between transmitting and receiving devices peer devices is handled in totality before transmitting device considers the request to have been successfully satisfied and removes request from persistent storage. This model negates the need for shutdown routines and allows device traffic to be guaranteed without service consumers and producers explicitly handling these events.

### Exemplary Method

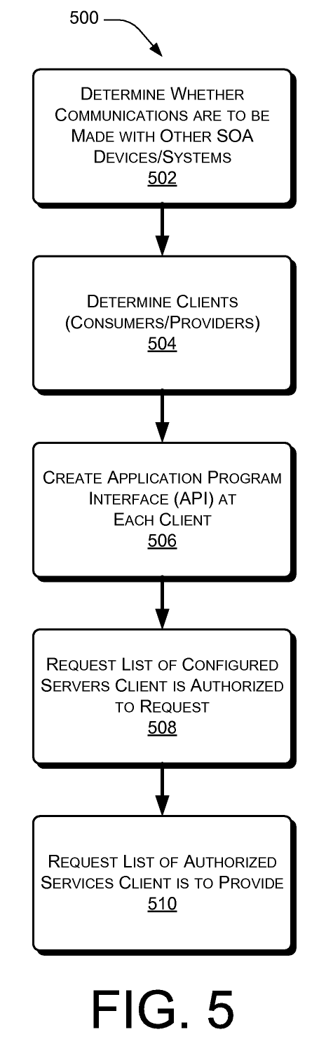

Exemplary SOA devices and systems for separating contaminants are described with reference to FIGS. 1-4. FIG. 5 illustrates an exemplary method 500 for interaction between SOA devices. The order in which the method is described is not intended to be construed as a limitation, and any number of the described method blocks can be combined in any order to implement the method.

At block 502, a determination is made as to whether communications are to be performed or interaction is to take place between an SOA device and other SOA devices. Communication may be performed between trusted peers(i.e., SOA devices/nodes) by standard encrypted IP traffic without proprietary protocols.

At block 504, a determination is made as to clients. Clients may be consumers and/or providers. As to consumer/provider interaction, each client (consumer/provider) that wishes to participate on an SOA network is provided with the ability to talk to the SOA devices or servers on the SOA network.

At block 506, an application program interface or API is provided. To provide client interaction, the API may be created by a configuration tool for each client. The API object may include a unique ID for the client. Furthermore, the client may have initialization code that discovers SOA devices or servers on the SOA network, send a unique ID to the SOA device or server. If the ID is authenticated and authorized, the API establishes connectivity, such as through TCP/IP, with the SOA device or server.

At block 508, a request is made as to a list of configured services that the client is authorized to request. The services may be exposed to a development environment or production environment via dynamically generated interfaces.

At block 510, a request is made as to a list of configured services that the client is expected to provide. Callback functions for each service may be programmed at runtime. When a message comes into the SOA device destined for a given client, the SOA device may send the message to the API via the aforementioned TCP/IP connection. The API uses the programmed callback method to deliver the message into the application where it is processed and responded to. Response occurs in a like fashion.

### CONCLUSION

While specific embodiments of the invention have been illustrated and described herein, as noted above, many changes can be made without departing from the spirit and scope of the invention. Accordingly, the scope of the invention should not be limited by the disclosure of the specific embodiments set forth above. Instead, the invention should be determined entirely by reference to the claims that follow.

What is claimed is:

1. An Service Oriented Architecture (SOA) device connected to a network, serving as a central authority for routing SOA traffic between applications that provide services into the network, wherein the SOA device is single indivisible package, comprising;
an operating engine configured to access encryption, compression and routing to support an operational requirement;
an encryption module accessed by the operating engine, which provides security for external and internal message traffic;
a compression module to compress and decompress the message traffic;
a routing module accessed by the operating engine, to determine the routing of at least one of message types, incoming traffic routed to appropriate service clients, and outbound traffic routed to an appropriate SOA device for disposition;
a security module configured to authenticate external traffic, such that messages are exchanged between SOA devices that have established a trust relationship, and to authorize authenticated traffic for further processing;
a first network interface used to connect the device to a local area network (LAN); and
a second network interface for to connect the device to an external wide area networks (WAN).

2. The device of claim 1, wherein the network interfaces are compliant with RJ45 component connector standard and support communications compliant with the Transfer Control Protocol/Internet Protocol (TCP/IP).

3. The device of claim 1, wherein the device is included in one of the following: a single printed circuit board used in a computer or backplane; a Personal Computer Memory Card International Association (PCMCIA) card; or an integrated circuit for incorporation into a computer motherboard.

4. The device of claim 1, wherein the device operates in one of the following: a wireless environment; a local area network (LAN) environment: or wide area network (WAN) environment.

5. The device of claim 1, wherein the device is resident on a single computer utilizing the device to route messages between applications and services.

6. The device of claim 1, wherein the device routes messages between a first computer hosting a set of application and services, and a second computer hosting a set of applications and services.

7. The device of claim 1, wherein the trust relationship is established by a process that includes an exchanged key-pair.

8. The device of claim 1 further comprising one or more of the following: a working dynamic storage; a static storage; a smart card reader; a universal serial bus (USB) interface; an expandable storage slot; capability to upgrade operational features and capabilities from firmware storage; and a keypad and display.

9. A system for Service Oriented Architecture (SOA) communication comprising:
a plurality of SOA nodes having a standardized hardware configuration, wherein the standardized hardware configuration comprises:
an operating engine;
an encryption module accessed by the operating engine, which provides security for message traffic;
a compression module to compress and decompress the message traffic;
a routing module accessed by the operating engine, to determine the routing of message types, incoming traffic routed to appropriate service clients, outbound traffic routed to appropriate SOA devices;
a security module that authenticates and authorizes message traffic; and
one or more network interfaces; and
one or more networks over which the SOA nodes communicate with one another.

10. The system of claim 9 used to secure SOA for key processes within one or more of the following: a single business enterprise, an office, a department, and a factory.

11. The system of claim 9 used to implement secure SOA for one of the following: e-commerce and inter-business processes; inter-business auction and bidding processes; financial business processes and transactions; logistics and support business processes and transactions; publication and printing industry; medical business processes and transactions; defense business processes and transactions; monitoring and situational awareness networks.

12. The system of claim 9 used to implement secure SOA for use in an environment supporting business processes mediated by the exchange of messages between network-based services in a secure environment.

13. A method comprising:
determining SOA clients, and whether the SOA clients are at least one of consumers and producers;
creating an application program interface at each client;
requesting a list of configured SOA servers that the SOA clients are authorized to request; and
requesting a list of authorized services the SOA clients are to provide.

14. The method of claim 13, wherein the determining the SOA clients is performed between trusted peers.

15. The method of claim 13, wherein the determining the SOA clients is through a standard non proprietary protocol.

16. The method of claim 13, wherein the creating the application program interface is created by a configuration tool for each client.

17. The method of claim 13, wherein the creating the application program interface includes clients providing a unique identifier (ID) which is authenticated and authorized.

18. The method of claim 13, wherein the requesting the list of configured SOA servers includes services authorized for each of the clients.

19. The method of claim 13, wherein the requesting a list of authorized services includes a programmed callback.

20. The method of claim 13, wherein the requesting includes SOA clients sending messages as to authorize services that the SOA clients provide.
